(19) United States
(12) Patent Application Publication
(10) Pub. No.: US 2012/0148265 A1
(43) Pub. Date: Jun. 14, 2012

(54) COHERENT OPTICAL RECEIVING DEVICE CAPABLE OF DIGITAL EQUALIZATION OF OPTICAL INPUT, DIGITAL EQUALIZATION METHOD FOR OPTICAL INPUT AND COHERENT OPTICAL TRANSMITTING/RECEIVING DEVICE

(75) Inventors: Sun-Hyok CHANG, Daejeon-si (KR); Hwan-Seok Chung, Daejeon-si (KR)

(73) Assignee: ELECTRONICS AND TELECOMMUNICATIONS RESEARCH INSTITUTE, Daejeon-si (KR)

(21) Appl. No.: 13/323,791

(22) Filed: Dec. 12, 2011

(30) Foreign Application Priority Data
Dec. 13, 2010 (KR) 10-2010-0127003

(51) Int. Cl. H04B 10/06

(52) U.S. Cl. 398/208

(57) ABSTRACT

A coherent optical receiving device capable of digital equalization of an optical input, and a method thereof. The coherent optical receiving device includes a chromatic dispersion compensating unit configured to comprise a filter for chromatic dispersion compensation and compensate for chromatic dispersion with respect to a digital signal that corresponds to an optical input using the filter; a decoder configured to generate a bit sequence of the signal which has been compensated for chromatic dispersion; a bit error calculating unit configured to calculate a bit error amount in the bit sequence; and a controller configured to monitor the bit error amount, determine a filter coefficient that makes the bit error amount a minimum, and set the determined filter coefficient in the chromatic dispersion compensating unit.

### CROSS-REFERENCE TO RELATED APPLICATION(S)

This application claims the benefit under 35 U.S.C. §119(a) of Korean Patent Application No. 10-2010-0127003, filed on Dec. 13, 2010, in the Korean Intellectual Property Office, the entire disclosure of which is incorporated herein by reference for all purposes.

### BACKGROUND

1. Field

The following description relates to a coherent optical receiving device for use in optical communications, and more particularly, to an equalizer based on digital signal processing and a method for optimizing the equalizer.

2. Description of the Related Art

In coherent optical communication, an optical signal is received by detecting an amplitude and phase difference of an optical input which interferes with a local oscillator optical source. Coherent optical communication has higher receiver sensitivity and is more robust against noise sources such as amplified spontaneous emission, compared to a direct scheme, and thus attention and researches on the coherent optical communication have been increasing.

Researches in 1980s on coherent optical communication showed that it was typical for an optical receiver for coherent optical communication to include an optical phase-locked loop (PLL) or an optical polarization controller in an effort to process an optical input. Moreover, the optical receiver had an equalizer to compensate for impairments such as chromatic dispersion and polarization mode dispersion, which occur in an optical path.

It is essential for the optical receiver to have configuration for control optical phase or polarization. In the prior art, optical phase or polarization control is performed in an optical domain with an optical method, but is inferior in terms of efficiency and practicality. However, with the development of digital signal processing technology, more attempts to digitally control optical phase or polarization have been made.

### SUMMARY

The following description relates to a method of a coherent optical receiving device for optimizing filter coefficients using information on bit error in an effort for equalization of an incoming signal.

In one general aspect, there is provided a coherent optical receiving device including: a chromatic dispersion compensating unit configured to comprise a filter for chromatic dispersion compensation and compensate for chromatic dispersion with respect to a digital signal that corresponds to an optical input using the filter; a decoder configured to generate a bit sequence of the signal which has been compensated for chromatic dispersion; a bit error calculating unit configured to calculate a bit error amount in the bit sequence; and a controller configured to monitor the bit error amount, determine a filter coefficient that makes the bit error amount a minimum, and set the determined filter coefficient in the chromatic dispersion compensating unit.

In another general aspect, there is provided a coherent optical transmitting and receiving device including: an optical receiver configured to split a received optical input by polarization and generate an analog signal with respect to an in-phase (I) signal and a quadrature-phase (Q) signal of each polarization; an analog-digital converter configured to convert the generated analog signal into a digital signal and deliver the digital signal to a chromatic dispersion compensating unit; the chromatic dispersion compensating unit configured to comprise a filter for chromatic dispersion compensation and compensate for chromatic dispersion of the digital signal that corresponds to the optical input using the filter; a decoder configured to generate a bit sequence of the signal which has been compensated for chromatic dispersion; a framer configured to frame the bit sequence for optical communication and calculate a bit error amount in the bit sequence; a controller configured to determine a filter coefficient that makes the bit error amount a minimum and set the determined filter coefficient in the chromatic dispersion compensating unit; and an optical transmitter configured to transmit the framed signal.

In another general aspect, there is provided a method of digitally equalizing an optical input, including: compensating for chromatic dispersion of a digital signal that corresponds to the optical input using a filter for chromatic dispersion compensation; generating a bit sequence of the signal which has been compensated for chromatic dispersion; calculating a bit error amount in the bit sequence; determining a filter coefficient that makes the bit error amount a minimum; setting the determined filter coefficient in the filter; and compensating for chromatic dispersion of an input digital signal using the filter having the determined filter coefficient set therein.

Other features and aspects may be apparent from the following detailed description, the drawings, and the claims.

### BRIEF DESCRIPTION OF THE DRAWINGS

FIG. 1 is a diagram illustrating a coherent optical receiving device for digital equalization.

FIG. 2 is a diagram illustrating an example of an optical receiver and a signal processing unit shown in the example illustrated in FIG. 1.

FIG. 3 is a diagram illustrating an example of a digital signal processing unit shown in the example illustrated in FIG. 2.

FIG. 4 is a diagram illustrating an example of a chromatic dispersion compensating unit shown in the example illustrated in FIG. 3.

FIG. 5 is a diagram illustrating an example of a polarization compensating unit shown in the example illustrated in FIG. 3.

FIG. 6 is a flowchart illustrating an example of a method of a chromatic dispersion compensating unit optimizing a filter coefficient for digital equalization.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

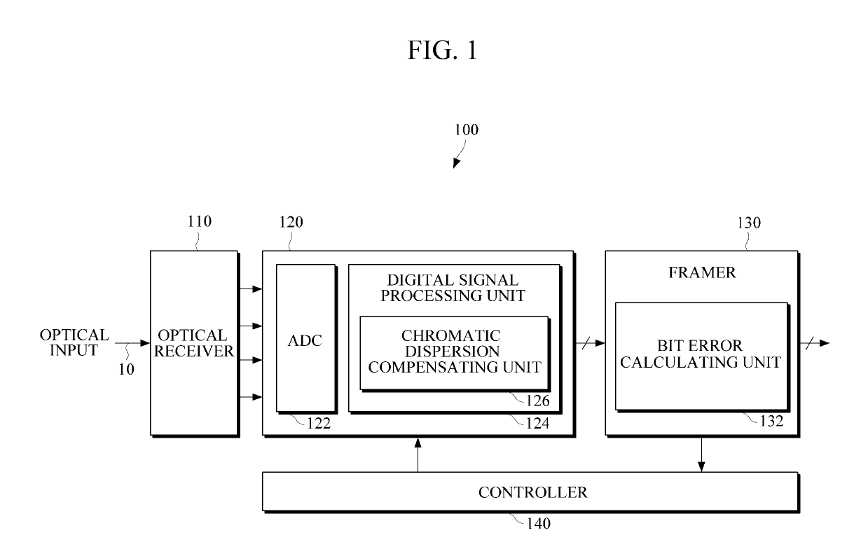

FIG. 1 illustrates a diagram of a coherent optical receiving device for digital equalization.

The coherent optical receiving device 100 may include an optical receiver 110, a signal processor 120, a framer 130, and a controller 140.

The optical receiver 110 may receive an optical input 10 transmitted for a long distance over an optical fiber, and convert the received optical input into an electrical signal. The optical input 10 may be transmitted using a high-order multi-level transmission format. For example, the optical input 10 may be in a transmission modulation format of polarization-division-multiplexed quadrature-phase-shift-keying (PDM-QPSK) for 100 Gb/s transmission, and may vary in modulation format.

In QPSK modulation, phase information at 0, 90, 180, and 270 degrees are applied to an optical input and these phase values are received to learn bit information. In QPSK modulation, every one symbol has two-bit information. Two polarization elements that are orthogonal to each other may be respectively modulated into QPSK and combined together, thereby producing a PDM-QPSK signal, which enables transmission of four bits of information per symbol. That is, 100 Gb/s transmission at a rate of 25 Gsymbol/s is possible. In future, in addition to QPSK, a multi-level signal such as 16-quadrature amplitude modulation (16-QAM) or 64-QAM may be available at transmission rate more than 100 Gb/s.

The optical receiver 110 may split the received optical input by polarization, and generate an analog signal for each polarization with respect to an in-phase (I) signal and a quadrature-phase (Q) signal.

The signal processor 120 may include an analog-digital converter (ADC) 122 and a digital signal processing unit 124.

The ADC 122 may convert an analog signal generated by the optical receiver 110 into a digital signal.

The digital signal processing unit 124 may process optical problems related to the converted digital signal, which occur in coherent reception, such as frequency offset estimation and carrier phase estimation. In addition, the digital signal processing unit 124 may perform various functions, such as polarization tracking and compensation for chromatic dispersion and polarization mode dispersion which may occur on an optical path.

In particular, for compensation for chromatic dispersion, the digital signal processing unit 124 may include a chromatic dispersion compensating unit 126 to compensate a digital signal for chromatic dispersion. The chromatic dispersion compensating unit 126 may be formed of a finite impulse response (FIR) filter. The chromatic dispersion compensating unit 126 may use a filter coefficient of the FIR filter to compensate for the chromatic dispersion of a digital signal corresponding to an optical input. In addition, the digital signal processing unit 124 may generate a bit sequence with respect to the digital signal which has been compensated for the chromatic dispersion, and transfer the bit sequence to the framer 130.

The framer 130 may change the bit sequence received from the signal processing unit 120 into frames in a transmission format for optical communications. The framer 130 may include a bit error calculating unit 132 to calculate a bit error amount in the bit sequence. The bit error calculating unit 132 may execute a forward error correction code for detecting a bit error in the input bit sequence.

The digital signal processing unit 120 may be connected with the framer 130 by Serdes framer interface (SFI)-S, SFI-5 or an equivalent parallel interface which is standardized by the optical internetworking forum (OIF).

The framer 130 may frame an input bit sequence according to a specific frame structure of optical transport hierarchy (OTH), synchronous digital hierarchy (SDH), or synchronous optical network (SONET).

If a value of chromatic dispersion of an optical link to which the input signal is transferred is known, the FIR filter coefficient of the FIR filter may be calculated by a formula. However, generally it is difficult to know in advance chromatic dispersion of an optical link and it is not possible to define a chromatic dispersion value in advance when a coherent optical receiver is installed.

In one example, the controller 140 may be capable of calculating a filter coefficient based on an arbitrary chromatic dispersion value, and set the calculated filter coefficient in the chromatic dispersion compensating unit 126 of the digital signal processing unit 124. The bit sequence with respect to the digital signal processed by the chromatic dispersion compensating unit 126 may input to the framer 130, and the bit error calculating unit 132 of the framer 130 may calculate a bit error amount in the bit sequence and feed back the calculated bit error amount to the controller 140.

The controller 140 may change an arbitrary reference chromatic dispersion value and monitor the bit error amount fed back from the bit error calculating unit 132. The controller 140 may determine a chromatic dispersion value that makes the bit error amount the minimum as an optimal chromatic dispersion value, calculate a filter coefficient based on the optimal chromatic dispersion value, and set (or update) the calculated filter coefficient in the chromatic dispersion compensating unit 246. After the optimal filter coefficient has been set in the chromatic dispersion compensating unit 246, the chromatic dispersion compensating unit 246 may compensate an input digital signal for chromatic dispersion by use a filter that operates according to the set filter coefficient.

The coherent optical receiving device 100 may further include an optical transmitter to transmit the signal framed by the framer 130 although it is not illustrated, and thereby may be implemented as a coherent optical transmitting and receiving device.

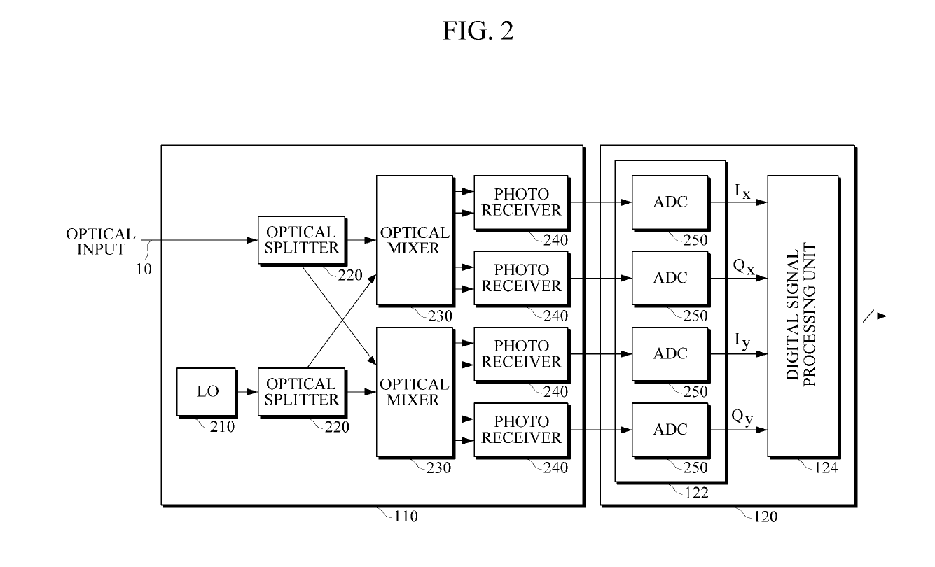

FIG. 2 illustrates a diagram of an example of an optical receiver and a signal processing unit shown in the example illustrated in FIG. 1.

The optical receiver 110 may include a local oscillator 210, an optical splitter 220, an optical mixer 230, and a photo receiver 240.

The optical splitter 220 may split a received optical input 10 into two arbitrary perpendicular polarizations. The optical splitter 220 may be a polarization beam splitter (PBS), and split the received optical input 10 into x-polarization and y-polarization.

The local oscillator 210 may generate a local oscillation signal, and output the generated local oscillation signal to the optical splitter 220. The optical splitter 220 may split the local oscillation signal into two perpendicular polarizations. The optical input 10 and x- and y-polarization components of the local oscillation signal are input to the optical mixer 230.

The optical mixer 230 may combine the optical output 10 and the local oscillation signal in such a way they have the same polarization component. The optical mixer 230 may be a 90° optical hybrid that combines signals to output a signal having a phase difference of 90°.

An output from the optical mixer 230 is delivered to the photo receiver 240. The photo receiver 240 may convert each of the received signals into an analog signal. With respect to each of two polarization components, there are signals corresponding to I and Q, and thus outputs from the photo receiver 240 may be four signals including Iₓ, Qₓ, I_{y}, and Q_{y}.

The signal processor 120 may include an ADC 122 and a digital signal processing unit 124. The ADC 122 may be formed of a plurality of ADCs 250. An output from the photo receiver 240 may be converted into a digital signal by each of the ADCs 250. Outputs from the ADCs 250 may be delivered to the digital signal processing unit 124. The digital signal processing unit 124 may output a signal that has undergone digital signal processing and is decoded into bit information. The ADC 122 and the digital signal processing unit 124 may be implemented as an ADC/DSP application specific integrated circuits (ASIC), and may vary in form.

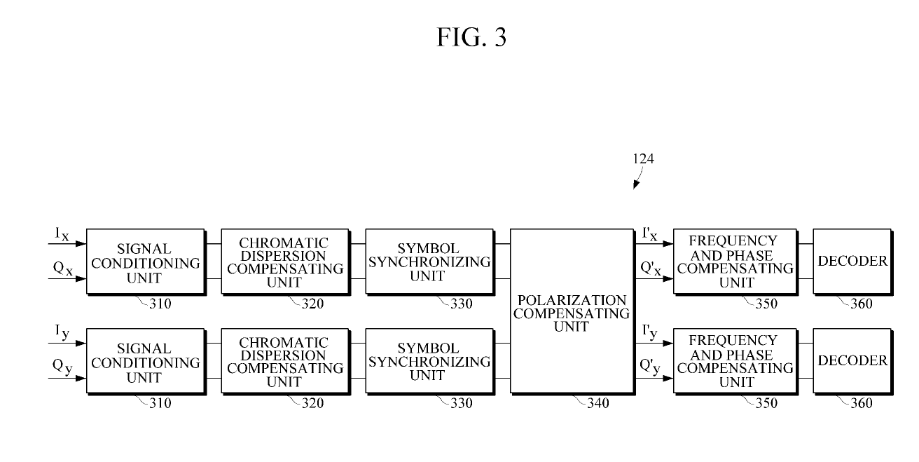

FIG. 3 illustrates a diagram of an example of a digital signal processing unit shown in the example illustrated in FIG. 2.

The digital signal processing unit 124 may include a signal conditioning unit 310, a chromatic dispersion compensating unit 320, a symbol synchronizing unit 330, a polarization compensating unit 340, a frequency and phase compensating unit 350, and a decoder 360.

The signal conditioning unit 310, the chromatic dispersion compensating unit 320, the symbol synchronizing unit 330, and the frequency and phase compensating unit 350 are provided for the respective polarization components, and each of these units 310, 320, 330, and 350 may be configured to process an I-channel signal and a Q-channel signal differently. Equalization of an incoming signal may be performed by the chromatic dispersion compensating unit 320 and the polarization compensating unit 340. The chromatic dispersion compensating unit 320 may correspond to the chromatic dispersion compensating unit 126.

The signal conditioning unit 310 may be included in the digital signal processing unit 124 in a case where signal conditioning is necessary for an incoming signal. The signal conditioning unit 310 may perform normalization and IQ-mismatch compensation for the incoming signal.

The chromatic dispersion compensating unit 320 may process an output from the signal conditioning unit 310 to compensate for chromatic dispersion with respect to a digital signal corresponding to the optical input 10 in an effort to compensate for chromatic dispersion of the optical signal 10 incoming during optical transmission. Because chromatic dispersion is a linear phenomenon, chromatic dispersion may be compensated for based on a chromatic dispersion value of an optical fiber that constitutes a transmission path. For example, chromatic dispersion may be compensated for by FIR filtering with a filter coefficient derived from the chromatic dispersion value of the optical fiber.

As described above, the controller 140 shown in the example illustrated in FIG. 1 may initially calculate a filter coefficient with respect to a reference chromatic dispersion value, set the filter coefficient in the chromatic dispersion compensating unit 320, and monitor a bit error amount that is output by the bit error calculating unit 132 with respect to the calculated filter coefficient. In addition, the controller 140 may change the reference chromatic dispersion value, calculate a filter coefficient with respect to the changed chromatic dispersion value, update the filter coefficient in the chromatic dispersion compensating unit 320, and monitor a bit error amount. The controller 140 may repeat the aforementioned operations until the bit error amount becomes a minimum. The controller 140 may determine an optimal chromatic dispersion value that makes the bit error amount a minimum, calculate a filter coefficient with respect to the determined chromatic dispersion value, and set the calculated filter coefficient in the chromatic dispersion compensating unit 320. Thereafter, the chromatic dispersion compensating unit 320 may compensate a digital signal for chromatic dispersion using the filter coefficient determined based on the optimal chromatic dispersion value.

The symbol synchronizing unit 330 may process an output from the chromatic dispersion compensating unit 320 to perform symbol synchronization. The optical receiving device 100 may require to reproduce a clock signal from a received signal for synchronization of the received signal and to reproduce the received signal using the clock signal. In this case, the reproduction of the clock signal is referred to as clock recovery, and the reproduction of the received signal is referred to as data recovery. The symbol synchronizing unit 330 may perform both clock recovery and data recovery simultaneously in a digital manner.

For example, the symbol synchronizing unit 330 may be able to sample specific data in a symbol domain, and at this time, sampling time may be different from sampling timing of the ADC 250 and may be determined by timing error detection and feedback of the detected timing error. That is, in a case in which a sampling rate of the ADC 250 and a sampling rate of a modulated optical input are not synchronized with each other, the symbol synchronizing unit 330 may operate to obtain two samples per symbol.

An output from the symbol synchronizing unit 330 may be delivered to the polarization compensating unit 340. The polarization compensating unit 340 may process the signal on which digital symbol synchronization has been performed in an effort to compensate for polarization-dependent impairments. The polarization-dependent impairments may include polarization mode dispersion (PMD), polarization-dependent loss (PLD) and the like. Moreover, the polarization compensating unit 340 may perform polarization recovery, residual dispersion compensation, or the like.

For example, when the optical input is divided into two polarization components, a modulated x-polarization component (e.g., x1) and a modulated y-polarization component (e.g., y1) may be mixed into one of polarization components. The polarization compensating unit 340 may split the modulated x-polarization component x1 and the modulated y-polarization component y1 from each of the polarization components.

An output from the polarization compensating unit 340 may be delivered to the frequency and phase compensating unit 350. Referring to FIG. 1 again, the optical mixer 230 may be configured to make the received optical input interfere with a local oscillator signal generated by the local oscillator 210. In this case, a laser frequency offset may occur between the optical input and the local oscillation signal. The frequency and phase compensating unit 350 may estimate the laser frequency offset, and compensate for the estimated laser offset. A method for compensating for laser frequency difference may be referred to as frequency offset estimation. Since the received optical input and the local oscillation signal have finite laser lindwidth, a phase noise may occur and thus the frequency and phase compensating unit 350 may be configured to compensate for the phase noise. A method for compensating for the phase noise is referred to as carrier phase estimation.

When the frequency and phase compensating unit 350 compensates for the frequency offset and the phase noise as described above, an output signal from the frequency and phase compensating unit 350 is allowed to have the same phase information as phase information of a signal transmitted from a transmission end that has initially transmitted the optical input, that is, phase-shift-keying (PSK) modulated phase information.

An output signal from the frequency and phase compensating unit 350 is delivered to the decoder 360. The decoder 360 may decode the delivered output signal by extracting bit sequence from the phase information included in the output signal from the frequency and phase compensating unit 350.

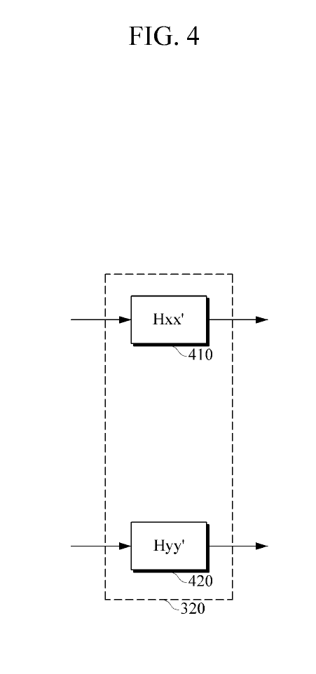

FIG. 4 illustrates a diagram of an example of a chromatic dispersion compensating unit shown in the example illustrated in FIG. 3.

The chromatic dispersion compensating unit 320 may be formed of FIR filters 410 and 420 having fixed filter coefficients, as shown in the example illustrated in FIG. 3. The filter coefficients with respect to the FIR filters 410 and 420 may be calculated by the controller 140 and set in the FIR filters 410 and 420, as the example described with reference to FIG. 1. Moreover, the FIR filters 410 and 420 may have a filter coefficient set therein, which minimizes a bit error amount calculated by the controller 140, and thus the FIR filters 410 and 420 may enable to compensate for chromatic dispersion using the filter coefficient applied for an input digital signal.

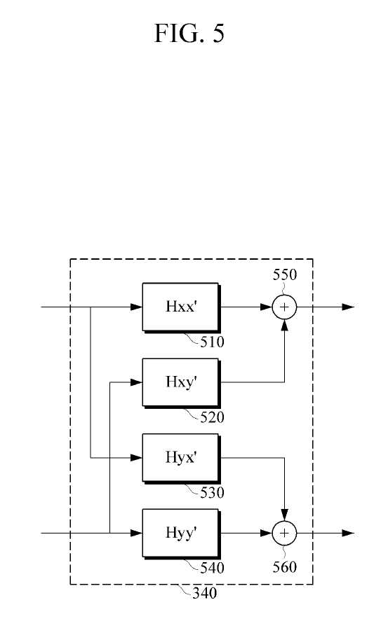

FIG. 5 illustrates a diagram of an example of a polarization compensating unit shown in the example illustrated in FIG. 3.

The polarization compensating unit 340 may be formed of FIR filters 510, 520, 530, and 540, each having adaptive filter coefficients, as shown in the example illustrated in FIG. 4. Polarization mode dispersion may change in value with time, and change in input polarization state as well, and thus the filter coefficients of the FIR filters 510, 520, 530, and 540 may be calculated adaptively. To determine the filter coefficients of the FIR filters 510, 520, 530, and 540, for example, a constant modulus algorithm (CMA) or a decision-directed (DD) scheme may be used.

An output from the FIR filter 510 and an output from the FIR filter 520 may be added together by a first addition unit 550, and an output from the FIR filter 530 and an output from the FIR filter 540 may be added together by a second addition unit 560. Signals which are generated, as result of the addition, by each of the first addition unit 550 and the second addition unit 560 are output to the frequency and phase compensating unit 350.

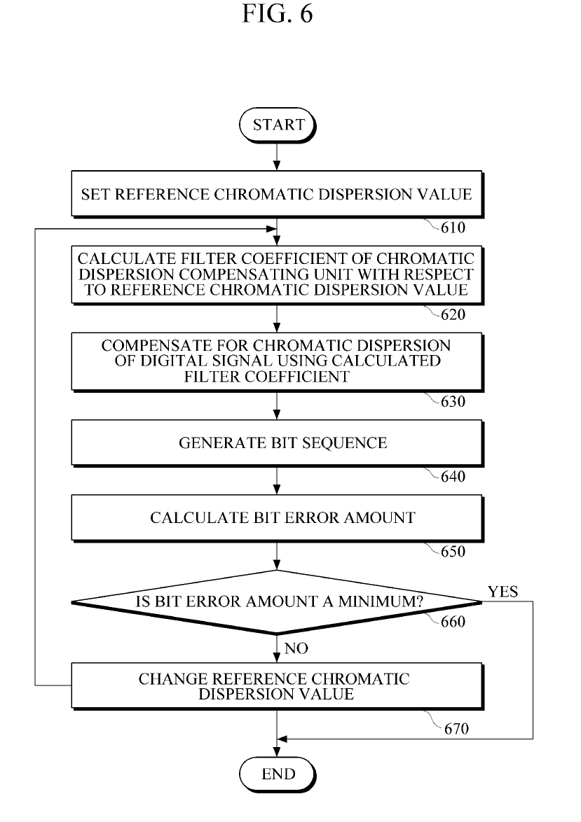

FIG. 6 illustrates a flowchart of an example of a method of a chromatic dispersion compensating unit optimizing a filter coefficient for digital equalization.

In operation 610, initially a reference chromatic dispersion value is set. The reference chromatic dispersion value may be set as an arbitrary value.

In operation 620, a filter coefficient of the chromatic dispersion compensating unit is calculated based on the set reference chromatic dispersion value. In operation 630, the chromatic dispersion compensating unit having the calculated filter coefficient set therein compensates for chromatic dispersion with respect to a digital signal corresponding to an optical input. In operation 640, a bit sequence of the signal having chromatic dispersion compensated is generated. A bit error amount in the bit sequence is calculated in operation 650. The calculation of the bit error amount in operation 650 may be performed while error correction coding is performed in the course of framing the bit sequence for optical communications.

It is determined whether the bit error amount becomes a minimum in operation 660. Various methods may be employed to determine whether the bit error amount becomes a minimum. For example, a minimum value of the bit error amount may be predefined and the determination may be performed based on the predefined minimum value.

Alternatively, in a case where a certain minimum value is repeatedly obtained as a bit error amount more than a predefined number of times, the value may be determined as a final minimum value of the bit error amount.

If the bit error amount does not become a minimum in operation 660, the reference chromatic dispersion value is changed in operation 670, a filter coefficient with respect to the changed chromatic dispersion value is calculated in operation 620, chromatic dispersion is compensated using the calculated filter coefficient with respect to the digital signal in operation 630, a bit sequence of a signal having the chromatic dispersion compensated is generated in operation 650, and it is determined whether a bit error amount becomes a minimum in operation 660. These operations 670, 620, 630, 640, 650, and 660 may be repeated until the bit error amount becomes a minimum.

If it is determined that the bit error amount becomes a minimum in operation 660, chromatic dispersion compensation with respect to an input digital signal may be performed using the determined filter coefficient.

As described above, without previously learning a characteristic of an optical fiber, that is, a chromatic dispersion value, an equalizer of a coherent optical receiving device may be optimized.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A coherent optical receiving device comprising:
a chromatic dispersion compensating unit configured to comprise a filter for chromatic dispersion compensation and compensate for chromatic dispersion with respect to a digital signal that corresponds to an optical input using the filter;
a decoder configured to generate a bit sequence of the signal which has been compensated for chromatic dispersion;
a bit error calculating unit configured to calculate a bit error amount in the bit sequence; and
a controller configured to monitor the bit error amount, determine a filter coefficient that makes the bit error amount a minimum, and set the determined filter coefficient in the chromatic dispersion compensating unit.

2. The coherent optical receiving device of claim 1, wherein the controller is further configured to initially calculate a filter coefficient with respect to a reference chromatic dispersion value, set the filter coefficient with respect to the reference chromatic dispersion value in the chromatic dispersion compensating unit, and monitor a bit error amount with respect to the calculated filter coefficient that is output from the bit error calculating unit.

3. The coherent optical receiving device of claim 2, wherein the controller is further configured to change the reference chromatic dispersion value, calculate a filter coefficient with respect to the changed chromatic dispersion value, update the calculated filter coefficient in the chromatic dispersion compensating unit, and monitor the bit error amount.

4. The coherent optical receiving device of claim 3, wherein the controller is further configured to repeat operations of changing the reference chromatic dispersion value, calculating the filter coefficient with respect to the changed reference chromatic dispersion value, updating the changed filter coefficient in the chromatic dispersion compensating unit and monitoring the bit error amount until the bit error amount becomes a minimum.

5. The coherent optical receiving device of claim 1, wherein the optical input may be a signal that is modulated in a transmission modulation format of polarization-division-multiplexed quadrature-phase-shift-keying (PDM-QPSK).

6. The coherent optical receiving device of claim 1, further comprising:
an optical receiver configured to split the received optical input by polarization, and generate an analog signal with respect to an in-phase (I) signal and a quadrature-phase (Q) signal of each polarization;
an analog-digital converter configured to convert the generated analog signal into a digital signal and deliver the digital signal to the chromatic dispersion compensating unit;
a symbol synchronizing unit configured to perform symbol synchronization on the digital signal which has been compensated for chromatic dispersion by the chromatic dispersion compensating unit;
a polarization compensating unit configured to receive an output from the digital symbol synchronizing unit and compensate for polarization impairments of the digital signal; and
a frequency and phase compensating unit configured to receive an output from the polarization compensating unit, compensate for phase noise and a phase difference between the optical input and a local oscillation signal used by the optical receiver, and deliver to the decoder the digital signal which has been compensated for the phase noise and the frequency difference.

7. The coherent optical receiving device of claim 1, wherein the bit error calculating unit is further configured to be included in a framer that frames the bit sequence into optical communication transmission format for optical communications.

8. The coherent optical receiving device of claim 7, wherein the framer is configured to frame the bit sequence into a transmission frame that is used by at least one of optical transport hierarchy (OTH), synchronous digital hierarchy (SDH), and a synchronous optical network (SONET).

9. A coherent optical transmitting and receiving device comprising:
an optical receiver configured to split a received optical input by polarization and generate an analog signal with respect to an in-phase (I) signal and a quadrature-phase (Q) signal of each polarization;
an analog-digital converter configured to convert the generated analog signal into a digital signal and deliver the digital signal to a chromatic dispersion compensating unit;
the chromatic dispersion compensating unit configured to comprise a filter for chromatic dispersion compensation and compensate for chromatic dispersion of the digital signal that corresponds to the optical input using the filter;
a decoder configured to generate a bit sequence of the signal which has been compensated for chromatic dispersion;
a framer configured to frame the bit sequence for optical communication and calculate a bit error amount in the bit sequence;
a controller configured to determine a filter coefficient that makes the bit error amount a minimum and set the determined filter coefficient in the chromatic dispersion compensating unit; and
an optical transmitter configured to transmit the framed signal.

10. The coherent optical transmitting and receiving device of claim 9, wherein the controller is further configured to change a reference chromatic dispersion value, calculate a filter coefficient with respect to the changed chromatic dispersion value, update the calculated filter coefficient in the chromatic dispersion compensating unit, and monitor change in the bit error amount, and the controller is further configured to repeat operations of changing the reference chromatic dispersion value, calculating the filter coefficient with respect to the changed reference chromatic dispersion value, updating the changed filter coefficient in the chromatic dispersion compensating unit and monitoring change in the bit error amount until the bit error amount becomes a minimum.

11. A method of digitally equalizing an optical input, comprising:
compensating for chromatic dispersion of a digital signal that corresponds to the optical input using a filter for chromatic dispersion compensation;
generating a bit sequence of the signal which has been compensated for chromatic dispersion;
calculating a bit error amount in the bit sequence;
determining a filter coefficient that makes the bit error amount a minimum;
setting the determined filter coefficient in the filter; and
compensating for chromatic dispersion of an input digital signal using the filter having the determined filter coefficient set therein.

12. The method of claim 11, wherein the determining of the filter coefficient that makes the bit error amount a minimum comprises
changing a chromatic dispersion value with respect to an initial reference chromatic dispersion value and calculating a filter coefficient with respect to the changed chromatic dispersion value,
to compensating for chromatic dispersion of the digital signal using the filter having the calculated filter coefficient set therein, generating the bit sequence of the signal which has been compensated for chromatic dispersion,
calculating the bit error amount in the bit sequence, and
monitoring change of the bit error amount.

13. The method of claim 12, further comprising:
repeating operations of changing the reference chromatic dispersion value, calculating the filter coefficient with respect to the changed reference chromatic dispersion value, compensating for chromatic dispersion of the digital signal using the filter having the calculated filter coefficient set therein, generating the bit sequence of the signal which has been compensated for chromatic dispersion, calculating the bit error amount in the bit sequence and monitoring change of the bit error amount until the bit error amount becomes a minimum.

14. The method of claim 11, further comprising:
framing the bit sequence for optical communications,
wherein the calculating of the bit error amount in the bit sequence is performed during the framing of the bit sequence.
